(19) United States
(12) Patent Application Publication
(10) Pub. No.: US 2020/0367466 A1
(43) Pub. Date: Nov. 26, 2020

(54) Pet Bed attached Fold-able Floor Pads

(71) Applicant: Donaldson Arlen June, Las Vegas, NV (US)

(72) Inventor: Donaldson Arlen June, Las Vegas, NV (US)

(21) Appl. No.: 16/420,193

(22) Filed: May 23, 2019

(51) Int. Cl. A01K 1/035

(52) U.S. Cl. CPC A01K 1/0353; A01K 1/0157

(57) ABSTRACT

An assembled fold-able floor pad attachments to a pet bed, designed to provide a place for owner to comfortably lay next to their pet. Four or three separate parts exist, one pet bed 100, three or two floor pads A, B, and/or C connected by cloth hinges 104 (which allow folding in one direction), each part is sewn, zippered, snapped, buttoned or Velcro together. Pet bed 100 attaches to a covered floor pad A, pad A may have Velcro on both sides for reversibility of said floor pads, thus A can accommodate right-sided or left-sided sleepers. Floor pad A is attached end-to-end to floor pad B and B to C (if needed). During naptimes an owner is able to unfold said floor pads into a mattress like arrangement to accompany a pet. User will occupy the unfolded floor pads, while the pet will occupy its' pet bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Regular pet beds do not accommodate humans to accompany a pet when pet is taking a nap or if the pet needs human closeness when a pet is ill. This invention came about during a time when the pet had taken ill and needed owner closeness.

Present pet beds which are pads will only allow a single pet to fit on the pad. And, usually the pet is left to themselves in a secluded spot on the floor. Often owners prefer closeness with their pets but are usually apprehensive about allowing the pet on furniture where there is little room for both or on the bed where there may be restrictions. Existing art does not allow the pet owner the option to join their pet momentarily during the day to be next to each other at the pet's level.

The opportunity arises to provide a spot close to a napping pet for the owner to join their pet for bonding time. Therefore, a need exist in the field of foam pet beds to accommodate human closeness. At this time no pet bed apparatus was found as prior art that accommodated pet/owner closeness.

Pets require a lot of sleep during the day. Often they nap frequently to function normally. This time is an opportunity for an owner to lay down next to the pet on the floor and take a 30 minute nap or so with their pet. This arrangement will also allow an owner to be close to an ill pet when the closeness is quite essential. The pet bed floor pads will fold-up under the pet bed when not in use and unfold out into a mattress attached to the pet bed to allow the owner to lay right next to the resting or napping pet.

### FIELD OF THE INVENTION

The present invention relates to fold-able floor pads attached to a Pet Bed for human use.

### DESCRIPTION OF RELATED ART

Regular pet beds do not allow humans to accompany a pet when taking a nap, sleeping or if the human or pet needs closeness during illness. Often the relationship between small children and pets are not accommodated in existing art.

Present pet beds which are pads that will only allow a single pet to fit on the pad but no room for a human to join the pet for special bonding time or for pets to give or receive closeness from its' owner. At the moment pet beds don't allow close intimate interaction with a human. The bed is place in a secluded spot on the floor maybe in a corner which distant pet from family members.

After an extensive search of related art, no pet bed including floor pad attachments were found. The existing art falls short of pet beds having an attached fold-able floor pads which will accommodate close interaction with pet and owner. Present art only includes a standalone pet bed. An arrangement where attached floor pads unfolding next to a pet bed will allow an owner to be close to an ill pet when the closeness is quite beneficial. The pet bed fold-able floor pads will fold back up under the pet bed when not in use and unfold out into a make-shift mattress attached to the pet bed. Present art has not been found to bring about such arrangement. Therefore, what is clearly needed is a pet bed with convenient attached fold-able floor pads which accommodates pet and owner interaction and address these shortcomings.

### BRIEF SUMMARY OF THE INVENTION

In one embodiment of the invention a fold-able floor pad attachment to a pet bed is provided, comprising of four or three separate parts (depending on size of pet bed); pet bed (1), three (3) or two (2) floor pads connected by a cloth hinge (which allow folding of floor pads in one direction). Each part is sewn, buttoned, snapped, zippered or Velcro together, when unfolded would brings about a place to lay near your pet. Pet bed attaches to a covered floor pad (A), (A) may have Velcro on both sides of the pad for the reversibility of pad (A), thus (A) can accommodate right-sided or left-sided sleepers. Floor pad (A) is attached end-to-end to floor pad (B) attached by a cloth hinge (104) which will allow folding of pad (B) under pad (A), in only one direction. Floor pad (B) is then attached end-to-end with floor pad (C) for a small pet bed. Whether, it is a three floor pad apparatus depends on how it will accommodate the height of the user or size of a pet bed. Two floor pads are easily accommodating in length when using a large pet bed, thus during the pet's naptime an owner is able to unfolded said floor pads (A), (B), and/or (C) into a mattress like arrangement to accompany a pet and owner's relaxation time. The user will occupy the unfolded floor pads while the pet will occupy its pet bed.

Therefore, an improved pet bed arrangement will accommodate pet, as well as owner. A folding floor pad arrangement attached to a pet bed used by owner which can conveniently fold up under pet bed and put out of the way when not in use.

### BRIEF DESCRIPTION OF THE SEVERAL VIEWS OF THE DRAWING(S)

FIG. 1 is a folded front view of pads folded under and attached to a pet bed according to an embodiment of the present invention.

FIG. 2 is a folded side view of Pet Bed attached Fold-able Floor Pads of FIG. 1.

FIG. 3 is an unfolded top view of Pet Bed attached Fold-able Floor Pads of FIG. 1 according to an embodiment of the present invention.

FIG. 4 is a front unfolded view of the Pet Bed attached Fold-able Floor Pads of FIG. 1 according to an embodiment of the present invention.

### DETAILED DESCRIPTION OF THE INVENTION

The inventor provides a pet bed with attached fold-able floor pads that becomes a mattress which when unfolded is affix close to the pet bed for user, allowing user to join pet for a nap. When folded it neatly folds back under the pet bed in two or three parts (depending on size of pet bed), allowing for continued pet use. The present invention is described in enabling detail in the following examples, which may represent more than one embodiment of the present invention.

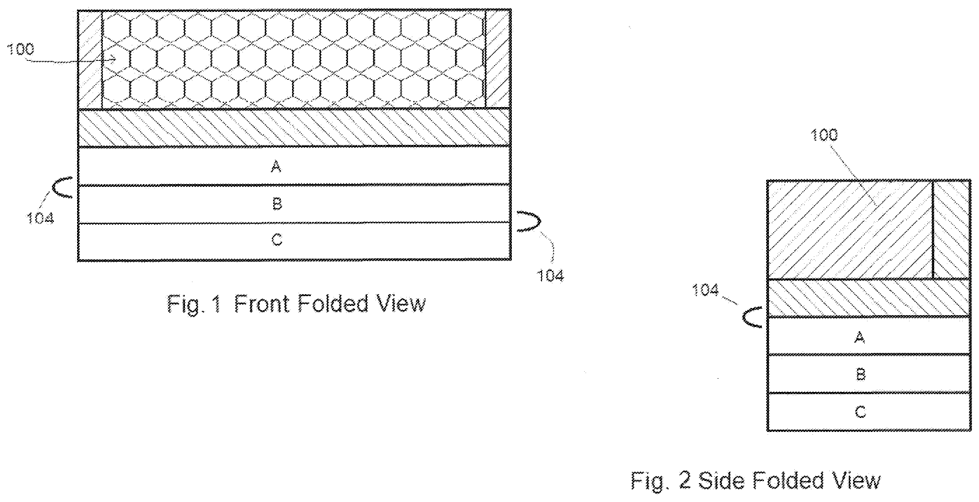

FIG. 1 is a perspective view taken from the front folded view of a pet bed 100 attached fold-able floor pads A, B and C constructed in accordance to an embodiment of the present invention. Pet Bed 100 in this example, is a pet bed found in the market today used by pets for resting upon, allowing something soft without using the hard floor or family furniture. The present invention combines pet bed 100 with three cushioned pads A, B, and C attached to 100, folded in a stack beneath 100. A cloth hinge 104 is shown connecting C to B and B to A in strategic locations on the pads to allow one-way folding of pads. Such cloth hinges may be sewn, zippered, snapped, buttoned or Velcro or attached by other means to each pad.

FIG. 2 is a side perspective view of the pet bed attachment A, B, and C showing hinge 104 attaching pet bed 100 to floor pads A, B, and C. FIG. 2 in this example shows the folded floor pads under the pet bed 100.

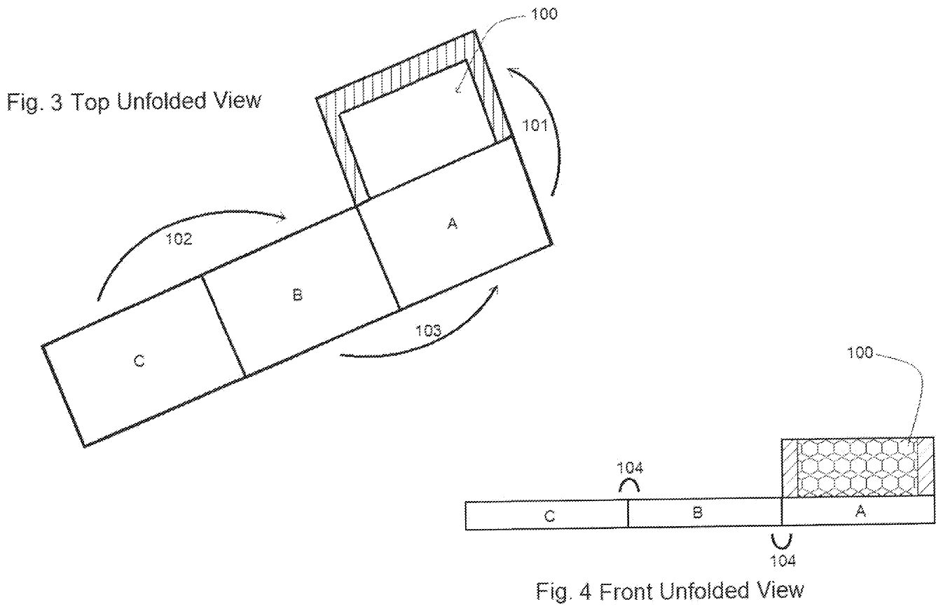

FIG. 3 is a top perspective view of the unfolded example of the invention. In this example, the pet bed 100 and attached floor pads A, B, and C, are unfolded with floor pads A, B, and C unfolding next to pet bed 100. A fold direction 101, 102, and 103 restricted by hinge 104, are folded in sequence 101 being the first fold, 102 being the second fold and 103 being the final fold to allow secure stacking of floor pads A, B, and C underneath pet bed 100 according to present invention.

FIG. 4 is a side unfolded perspective view example of the invention. In this example, the floor pads A, B, and C are laid out attached to pet bed 100 with cloth hinge 104 connecting the pads C to B and pads B to A. The unfolded floor pads A, B, and C unfold out into a mattress to allow owner to nap or rest beside their pet on cushions.

### REFERENCE NUMERALS

100 pet bed
A Pad attached to pet bed
B Pad attached to Pad A and C
C Pad attached to Pad B
101 Pad A under-fold
102 Pad C over-fold
103 Pad B under-fold
104 fold-able cloth hinges

It will be apparent to one with skill in the art that the pet bed attached fold-able floor pads for a user's mattress of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

Operation

In operation, one uses the unfolded floor pads (usually in three parts for a small 100 or two pads for a large 100) which are attached to the pet bed 100 for laying next to resting pet. When the floor pads A, B, and/or C are unfolded on the floor, where the pet bed is designated, the owner or user can comfortably lay on the unfolded floor pads and foster an ailing pet or to provide closeness with owner. A thirty minute nap would greatly enhance a pet and owner's relationship.

1. A floor pad attachments to a pet bed, comprising:
of four or three separate parts; pet bed 100, three or two floor pads A, B, and/or C
connected by cloth hinges 104 (which allow folding in one direction)
each part is sewn, snapped, buttoned, zippered or Velcro together to bring about a place to lay near one's pet
pet bed 100 attaches to a covered floor pad A, A may have Velcro on both sides for reversibility of A, thus A can accommodate right-side or left-side sleepers.
floor pad A is attached end-to-end to floor pad B attached by hinge 104 which will allow folding of B under A in only one direction
floor pad B is then attached end-to-end with floor pad C for a small pet bed, whether it is a three floor pad apparatus depends on how it will accommodate the height of the user. Two floor pads are easily accommodating in length when using a large pet bed 100,
whereby during the pet's naptime an owner is able to unfolded said floor pads A, B, and/or C into a mattress like arrangement to accompany a pet during relaxation or naptime. The user will occupy the unfolded floor pads while the pet will occupy its' pet bed.
